(19) United States
(12) Patent Application Publication
(10) Pub. No.: US 2008/0040216 A1
(43) Pub. Date: Feb. 14, 2008

(54) SYSTEMS, METHODS, AND APPARATUSES FOR ADVERTISEMENT TARGETING/DISTRIBUTION

(76) Inventor: DANIELLE F. DELLOVO, North Andover, MA (US)

Correspondence Address: CHADBOURNE & PARKE LLP, 30 ROCKEFELER PLAZA, NEW YORK, NY, 10112, US

(21) Appl. No.: 11/748,454

(22) Filed: May 14, 2007

Related U.S. Application Data
(60) Provisional application No. 60/747,176, filed on May 12, 2006.
(60) Provisional application No. 60/747,405, filed on May 16, 2006.
(60) Provisional application No. 60/824,888, filed on Sep. 7, 2006.

(51) Int. Cl. G06Q 30/00

(52) U.S. Cl. 705/14

(57) ABSTRACT

The application discloses apparatuses, systems and methods for selecting a base data entry for distribution with a content provider's requested content. More specifically, the disclosed system may be configured to receive and process a distribution advertisement request from a content provider or an affiliate. The system processes the advertisement request to extract content provider distribution parameters and/or web user data characteristics, if they exist. This data may be processed to create an initial a pool of potential base data entries, one (or more) of which will be distributed to a content provider. In an implementation, the system further processes the initial pool based on sponsor distribution parameters associated with the various base data entries that comprise the pool. Based on this analysis, the system selects one or more of the potential base data entries based on a variety of ad distribution considerations.

### PRIORITY CLAIMS AND RELATED APPLICATIONS

This disclosure claims priority to under 35 U.S.C. § 119 and incorporates by reference U.S. Provisional Patent Application Ser. No. 60/747,176, titled “Job Advertising Generation and Network for Distributing the Same,” filed May 12, 2006, Ser. No. 60/747,405, titled “Job Distribution Network,” filed May 16, 2006, and Ser. No. 60/824,888, titled “System and Method for Advertisement Generation, Selection and Distribution,” filed Sep. 7, 2006. The disclosure also incorporates pending, related non-provisional applications titled “Systems, Methods and Apparatuses for Advertisement Generation,” filed May 14, 2007, as Ser. No. ______; “Systems, Methods, and Apparatuses for Advertisement Generation, Selection and Distribution System Registration,” filed May 14, 2007 as Ser. No. ______; and “Systems, Methods and Apparatuses for Advertisement Evolution,” filed May, 14, 2007, Ser. No. ______, which are all incorporated herein by reference.

### FIELD OF THE INVENTION

The present invention is generally directed to apparatuses, methods and systems for managing advertising. More specifically, the present invention is related to apparatuses, systems and methods for targeting and distributing online advertisements.

### BACKGROUND OF THE INVENTION

Advertisements offering goods, services, or opportunities may be distributed according to a number of different methods. One such method involves using search terms entered into an online search engine to generate a listing of search results. The search terms may also be used to select advertisements for providing related goods or services. However, the related advertisements are generally for broadly available goods or services.

### SUMMARY OF THE INVENTION

The present invention relates to systems, methods and apparatuses for facilitating an Advertisement Targeting/Distribution engine. More specifically, embodiments of the system are configured for receiving and processing a variety of advertisement distribution parameters, selecting an underlying base data entry, and generating an advertisement from the base data entry for distribution to a web user. The system provides significant flexibility and may be configured to generate advertisements based on a variety of inputs. For example, advertisements may be created from sponsor defined distribution parameters, content provider distribution parameters, and/or web user characteristics independently or in a variety of combinations.

An embodiment of the system described herein is based on processing distribution parameters received in an advertisement request message and selecting an underlying base data entry (such as a Monster.com job listing) that serves as the basis for a distribution advertisement. The base data entry selection process significantly increases the likelihood that a given underlying data entry, as well as the corresponding distributed advertisement include subject matter that is relevant to the end web user and/or relevant to the type of data that the web user is viewing. Accordingly, the systems, methods and apparatuses described herein provide facilitate harnessing the broad distribution strength of the internet, in order to create and distribute advertisements for narrow goods, service, and/or opportunity in a unique synergy.

In accordance with another embodiment of the present invention, systems, methods, and apparatuses the targeting/distribution system disclosed may be configured for iterative optimization. More specifically, the targeting/distribution system may be configured to adjust the targeting procedure based on feedback from web users, base data entry sponsors and/or a system performance analysis module.

### BRIEF DESCRIPTION OF THE DRAWINGS

The accompanying appendices and/or drawings illustrate various non-limiting, representative, inventive aspects in accordance with the present disclosure:

FIG. 1 is an overview of various entities that may interact with the Engine at various points during system utilization;

FIG. 2 is a high-level diagram illustrating aspects of the advertisement targeting/distribution process;

FIG. 3 illustrates aspects of an affiliate registration process according to an implementation of the system;

FIG. 4A-4C illustrate aspects of sponsor system interaction associated with establishing sponsor advertisement targeting/distribution parameters;

FIG. 5A-5B illustrates aspects of web user identification;

FIG. 6 is a flow diagram illustrating aspects of a process flow associated with advertisement targeting according to an implementation of the system;

FIGS. 7A-7B illustrates aspects of creating advertisement request message and processing the advertisement request message, respectively, according to an implementation of the system;

FIG. 8 illustrates a flow diagram of the targeting and distribution process of another implementation of the system;

FIG. 9 illustrates aspects of the advertisement distribution process according to an implementation of the system;

FIG. 10 exhibits illustrates aspects of an advertisement targeting/distribution engine controller according to an implementation of the system;

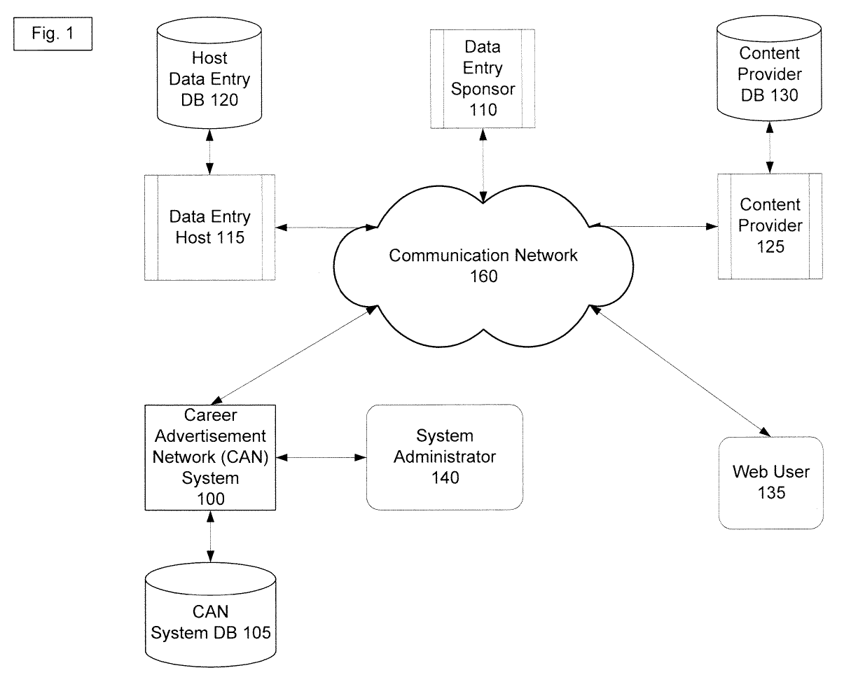

The leading number of each reference numeral indicates the first drawing in which that reference numeral is introduced. For example, content provider database (DB) 125 is first introduced in FIG. 1.

### DETAILED DESCRIPTION

The present disclosure includes a discussion of systems, methods, and apparatuses for an advertisement targeting/distribution engine (hereafter “Engine”). The Engine may be configured to receive an advertisement request message from a content provider, process a series of distribution parameters, select an underlying base data entry targeted for distribution, and generate an advertisement generated from the underlying base data entry. In one implementation, the Engine processes distribution parameters from a variety of sources, such as the advertisement sponsor, an advertisement affiliate/content provider, a web user, distribution parameters associated with the underlying base data entry, and/or historical distribution parameters.

It is to be understood that, while the system may be described herein primarily in the context of online advertisements (hereafter “Ads”), the system provides an administrator with significant flexibility and freedom to configure the system for any other number of information dissemination applications embodied in a wide array of media, including print, World Wide Web, television and radio, signs and billboards, product placement, postal and e-mail communications, and/or the like. Furthermore, although the system may be described herein processes distribution parameters from a variety of a sources, it is to be understood that, depending on the needs, parameters, specifications, etc. of a particular implementation, the system may be scaled and configured to process distribution parameters from a single source or any number of combinations of sources.

### BASIC OVERVIEW

FIG. 1 illustrates an implementation of the system providing an overview of various entities that may interact with the Engine at various points during system utilization. According to an implementation, the Career Advertisement Network (“CAN”) system 100 is a central element that may be configured to include the Engine and facilitate aspects of the functionality described herein. In the illustrated implementation, the CAN system 100 communicates with the CAN system database 105. As will be discussed in greater detail below, the CAN 100 processes distribution parameters from a variety of sources in order to select an underlying base data entry and generate a distribution advertisement based on the underlying base data entry.

As illustrated in FIG. 1, one of the sources may be a base data entry sponsor 110. For example, if the advertisement is generated from a base data entry configured as a Monster.com job listing, the sponsor is the entity that sponsors the job listing, whereas, the data entry host 115 may be analogized with Monster.com. The host entity manages underlying base data entries used to create the distributed advertisements in host base data entry DB 120 (in some embodiments, the host data entity may also provide parameters that are used to facilitate selection of the underlying base data entry). Although illustrated as independent elements in FIG. 1, in some embodiments, the functionality associated with the host entity 115 and the CAN system 100 may be incorporated into a single system. It is also to be understood that system facilitates a significant flexibility and other modifications of the various embodiments discussed herein are also possible.

In an implementation, distribution advertisements are generated based on an ad request message from content provider 125 that is transmitted to the CAN system as the content provider 125 prepares content (e.g., a web page) from content provider database 130 for display to a web user 135. The CAN system 100 provides a significant flexibility and scalability to meet the various needs of a number of data entry sponsors 110. Accordingly, a system administrator 140 can access and configure the CAN system to provide a variety of functionality customized for individual sponsors, as described below. For example, different CAN system 100 implementations can be customized to implement a basic or premium targeting/distribution advertisement engine. One difference between basic or premium sponsor subscriptions involves the scope of data processing capabilities of the CAN 100. In a premium subscription, the CAN 100 may be configured to target and distribute advertisements at an extremely granular level of detail.

As discussed, the system provides a significant flexibility and a system administrator can select from a variety of system functionality based on the needs of various base data entry sponsors and/or content providers. The following discussion is provided within the context of a sponsor providing a job listing as the base data entry, with an online job placement system such as Monster.com as the data entry host. However, it is to be understood that the system and functionality described herein may be configured to facilitate any number of implementations and/or applications. For example, the system may be configured to facilitate distribution of advertisements for financial products, travel services, real estate properties, classified advertisements, online auction entries and/or any other types of goods, services, or opportunities.

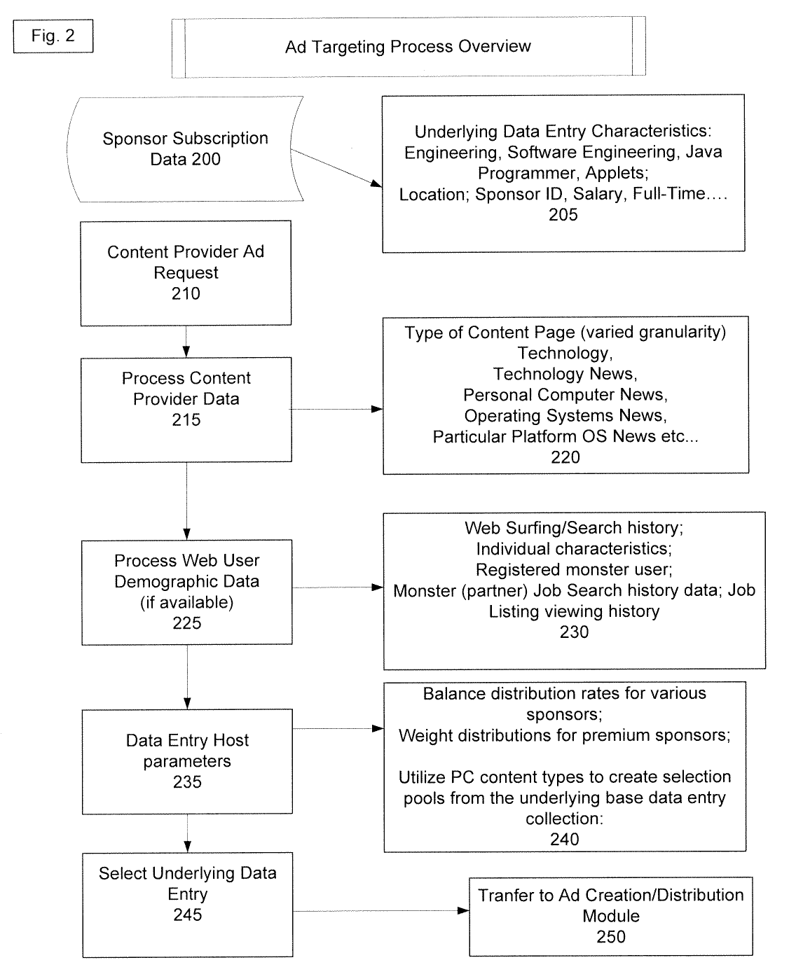

FIG. 2 is a high-level diagram illustrating aspects of the advertisement targeting process according to an implementation of the system. More specifically, the advertisement targeting process involves the process by which the CAN system 100 selects an underlying base data entry used to create a targeted advertisement for distribution. The advertisement is ‘targeted’ in the sense that the underlying base data entry is selected based on a number of distribution parameters processed by the CAN system. In FIG. 2, the sponsor can interact with the CAN 100 to establish a variety of sponsor established distribution parameters. In an implementation, the sponsor distribution parameters 200 relate to a variety of variables established during sponsor registration or campaign creation processes. The sponsor distribution parameters often relate to parameters that influence the selection of an underlying base data entry for distribution to either a particular web user and/or sponsor requested content provider characteristics.

The sponsor may work with a system administrator (or in some implementations a self-guided setup wizard) during the sponsor registration process to configure the CAN system to designate certain web users, categories of web users and/or content providers as requested targets. For example, a sponsor that has a number of job listings for entry level software engineering positions may request that the CAN system distribute advertisements based on the sponsor's underlying base data entries (BDEs) to a certain target distribution point. In this example, the sponsor may attempt to target individual web users that are accessing computer software related content providers.

Further, the sponsors may request that the distributed advertisements are displayed to web users who have been identified as being between the ages 18-24 or around the age of someone currently in college studying computer technologies or starting a career in a computer related industry. The CAN system 100 may also be configured to work with the sponsor to categorize a sponsor's underlying base data entries based on BDE content, distributed advertisement specs, and/or any number of sponsor distribution parameters. For example, the sponsor may provide a variety of job listing descriptor tags that are used by the system during the underlying BDE selection process.

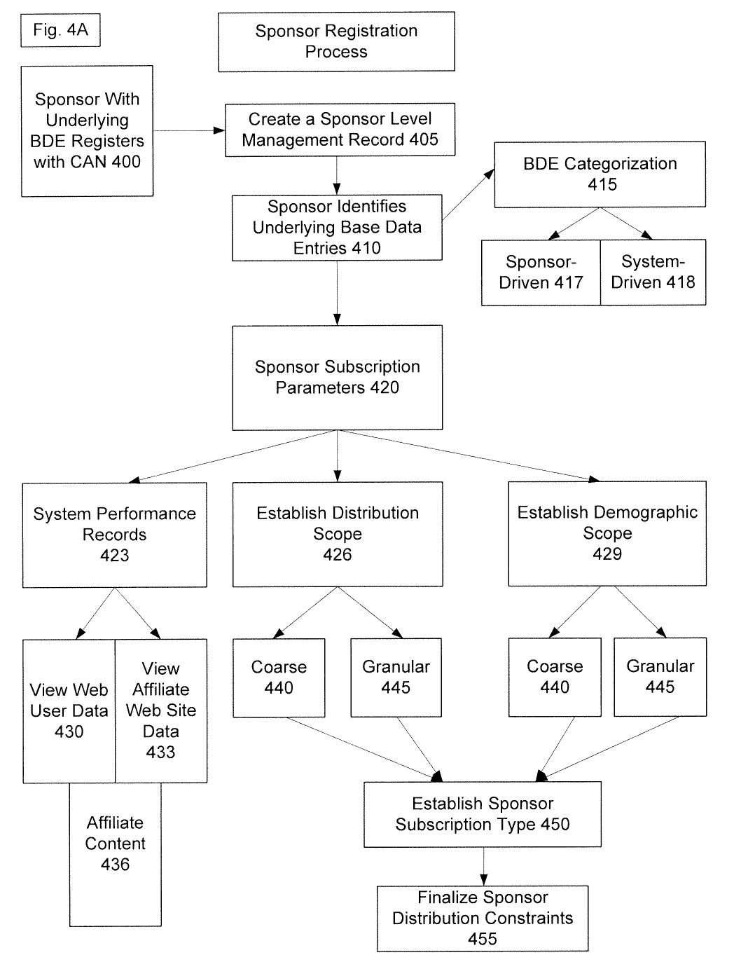

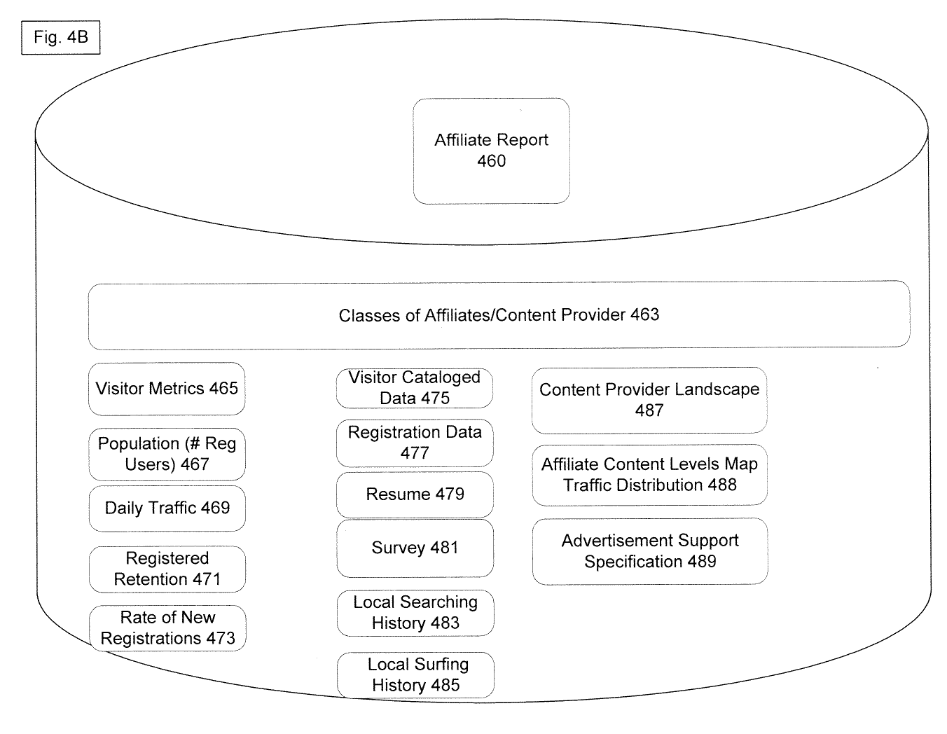

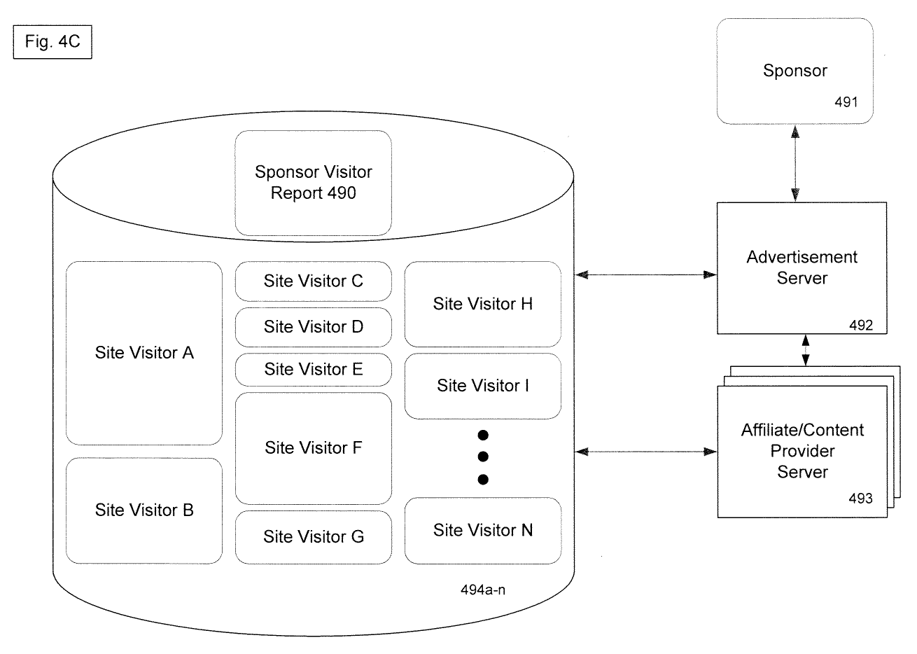

As illustrated, the sponsor may pursue various level of scope for job listing descriptors 205 (the varying level of scope may correspond to the sponsor's subscription type). For example, the sponsor may describe their job listings as falling within broad groups like engineering jobs, computer science or programming jobs. In some implementations, the sponsor may configure the distribution parameters to achieve a greater level of granularity. In such implementations, the sponsor may supplement the broad descriptors with more specific descriptors such as java programmer, applet programmer or other more specific key words that describe the job listing. It is to be understood that a variety of descriptors may be implemented and it is not limited to actual job type characteristics. For example, the sponsor descriptors may be based on salary range, sponsor identity, full-time positions, or other job descriptors. Aspects of the sponsor distribution parameters are discussed in greater detail below with regard to the FIGS. 4A-4C and the sponsor targeting/distribution registration process.

Additional distribution parameters may be incorporated within the content provider's ad request message 210. For example, in an implementation of the system, the ad request message may be configured with content provider distribution parameters and/or web user distribution parameters. The content provider distribution parameters relate to aspects of the distribution process centralized around the content provider.

In an implementation of the system, the content provider data 215 may include content provider data descriptors 220. For example, the content provider may include a descriptor of the various types of content they provide. In some implementations, the descriptors may also vary in terms of the breadth of the descriptor. As illustrated in FIG. 2, a content provider 215 may provide varying descriptors of their content 220. In the illustrated example, the content descriptors 220 range from very broad to become more focused, example descriptors may include: technology in general, technology news, personal computer news, operating systems for PCs, particular flavors of OS, etc. . . . By varying the descriptor breadth, a sponsor may select a level of scope that meets their needs and is cost effective (i.e., the system may be configured to provide greater levels of targeting granularity as premium services).

In some implementations, the content provider may be a system affiliate. Affiliates or partners of the CAN system may provide data from a historical user databases to the CAN system. In an implementation, partnerships may be formed to exchange historical user data for a portion of the distributed advertisement revenue. As such, the strategic partnerships may lead to a great deal of web user information. As part of the registration process, web users who register with an affiliate partner may agree to allow the affiliate to share certain web user data with partners.

FIG. 2 illustrates aspects of two examples of processing web user data 225. A first type of web user data may be provided based on a web user's registration with an affiliate web site and include a variety of web user characteristics such as some types of demographic information. A second type of web user data may be maintained by the affiliate web site involves web user/affiliate historical interaction. For example, a web user may authorize an affiliate to maintain records of the web user's surfing/search history within the affiliate web site, in addition to a variety of other interaction characteristics. By way of example only, if the affiliate site is Monster.com, a registered web user may authorize Monster.com to maintain data records regarding whether the registered user has uploaded a resume; what type of job the registered user has searched for within Monster.com; the types of job listings the registered web user has viewed or applied for, or any other number of affiliate/web user interactions.

The system may also incorporate distribution parameters that are determined specified by the base data entry host. In an implementation where the CAN system is incorporated with the base data entry host, the base data entry host manages several distribution parameters 235 related to attempting to balance selecting the most relevant underlying base data entry, while also satisfying distribution commitments for the various BDE sponsors. The base data entry host distribution parameters 235 may include distribution selection probabilities that are assigned to underlying BDEs.

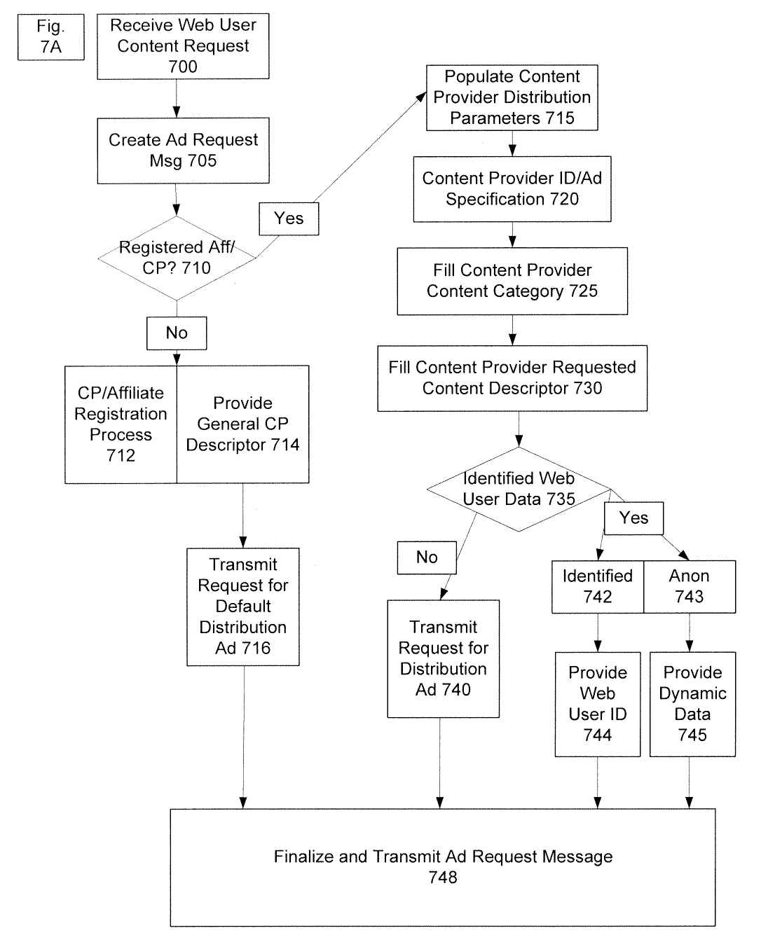

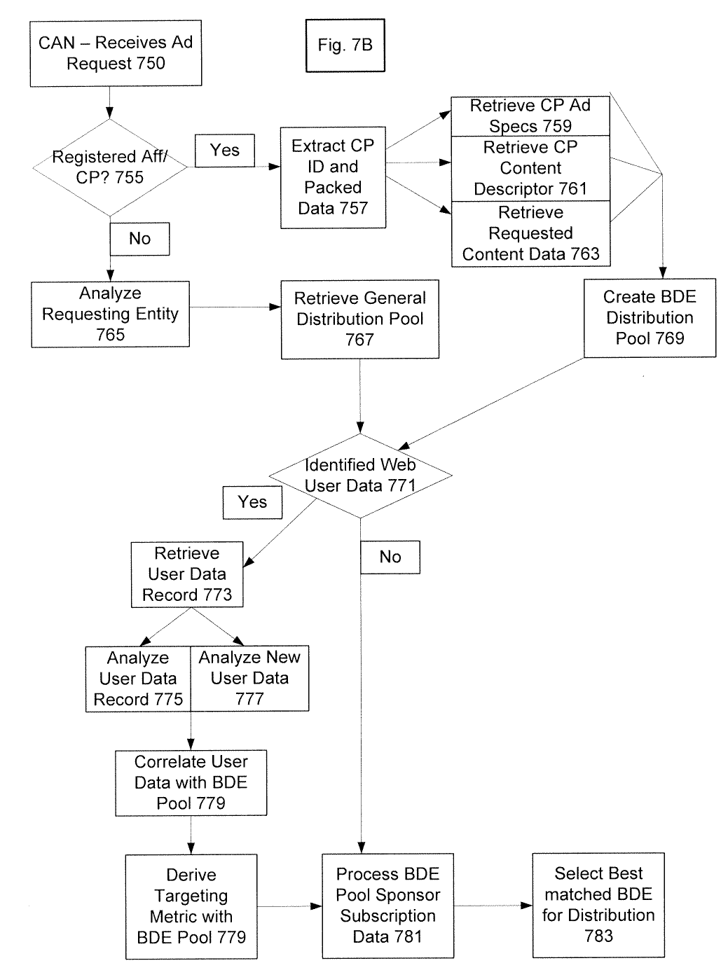

In some implementations, various sponsors may establish BDE distribution advertisement campaigns or subscriptions. For example, a sponsor may agree to pay a certain fee in exchange for assurances one or more underlying BDEs will be distributed a certain number of times, over the course of a certain time period, and in some instances to a certain categories of web users. As such, the data entry host parameters may include distribution selection weighting parameters. These data entry host parameters may be called sponsor distribution parameters. As will be described in greater detail below, in some implementations each BDE may be assigned a corresponding weighted selection probability. These weighted probabilities may be used by the CAN system in creating the selection pool of BDEs for distribution or making the final selection of the BDE for distribution as an advertisement (as discussed for example with regard to FIG. 7B).

The probabilities may be used to make distribution more or less likely in order to meet certain sponsor designated distribution goals. In some implementations, a sponsor may pay additional fees for a premium distribution campaign, wherein the selection probabilities associated with the sponsor's BDEs are all increased by a certain factor. The data host distribution parameters are established to correlate BDE selection categories (e.g., computer programming BDEs) with the distribution parameters received from the content provider (e.g., the type of content provided and/or any type of web user characteristics the provider may have). Once the correlations are executed, the selection pool of BDEs may be created for potentially relevant BDEs that the system may select for distribution. The CAN system selects an underlying BDE 245 and transfers the BDE to a CAN system ad creation module 250.

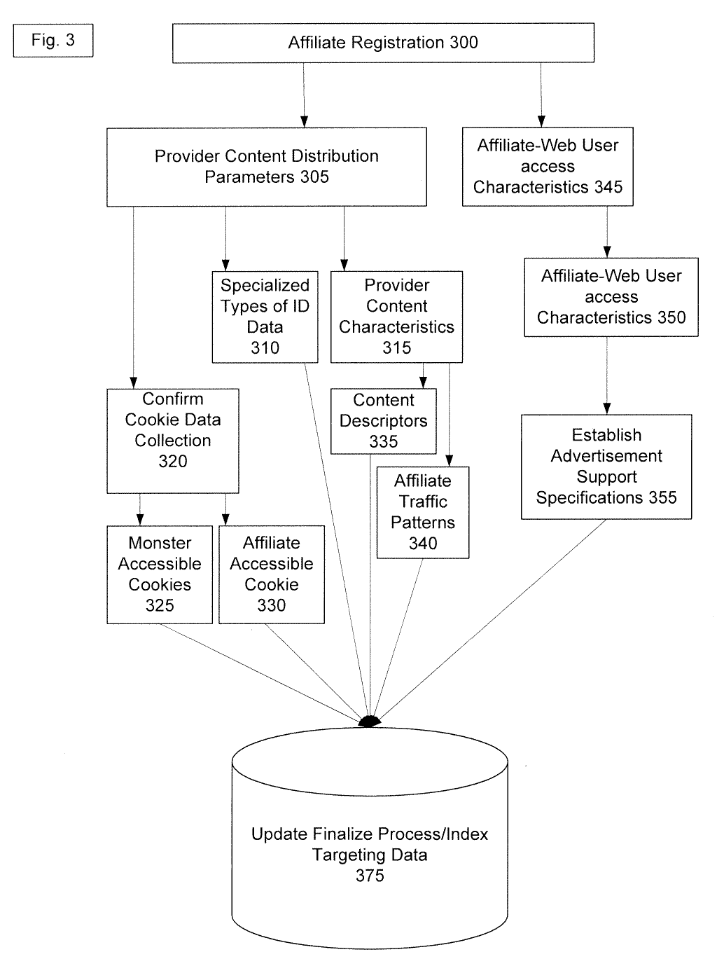

As discussed above, the BDE selection targeting is based on data provided by the content providers, in combination with sponsor and/or BDE host data. In some implementations, content providers may agree to provide additional web user data and become partners/affiliates of a the CAN system. FIG. 3 illustrates an affiliate registration process 300. As part of the registration process, an affiliate establishes a series of content provider distribution characteristics 305, which can be broken down into four types according to one implementation of the system. The first establishes a type of cookie 320 that can be included with a distributed advertisement, as well as the types of cookie data that can be processed by the system. Depending on the implementation, the affiliate may distribute data host 325 (e.g., Monster.com) cookies, as well as affiliate accessible cookies 330. At this point, the affiliate establishes the types of data that will be collected by affiliate cookies and transferred to the CAN system as part of the partnership.

Depending on the implementation, various affiliates may be configured uniquely positioned to collect specialized web user data 310. For example, affiliates configured as a employment placement websites may have databases with resume data associated with a particular web user or job search related data. Another example is an affiliate configured as a social networking web site. The social networking web site may utilize surveys to collect web user characteristic data that provides perspective on the likes or dislikes of a particular web user. These specialized data characteristics assist in selecting particularly relevant underlying BDEs for distribution to a web user.

Another type of content provider distribution parameter relates to characteristics associated with the provider's content 315. For example, the distribution parameters may include content descriptors 335 (e.g., technology; technology news; personal computer news; etc. . . . ). Also, the content provider may provide affiliate web site characteristics 340 such as values of average/peak affiliate network traffic volume or other affiliate web site characteristics.

Another aspect of the affiliate registration process involves transferring available historical affiliate-web user access characteristics 345. For example, web users may allow an affiliate to participate in transferring historical web user search/surfing data to help develop the CAN system database. This type of data may relate to previous affiliate-web user access/interaction characteristics (e.g., searching the affiliate web site for data related to computer programming jobs) 350. Alternately, the affiliate access characteristics may define what types of distributed advertisements are supported by the content provider/affiliate 355. The various distribution parameters are established and associated with an affiliate/content provider data record within the CAN system database 375. Accordingly, in an implementation, the CAN system can easily determine which types of data parameters are included with ad request from a particular affiliate/content provider by accessing a data record associated with a content provider ID. Establishing the content provider distribution parameters may be only the first step toward configuring the Engine.

FIG. 4A illustrates a flow diagram associated with the sponsor registration process. A base data entry (BDE) sponsor starts the registration process with a CAN system interface or by working with a CAN system administrator host 400. The system creates a sponsor management record 405. The sponsor management record includes a listing of sponsor identified BDEs 410, as well as descriptors related to categorizing a sponsor's BDEs. As discussed above, BDEs may be categorized through a variety of BDE data characteristics, (e.g., job type with various scaling—computer programming, java programming, etc. . . . , other characteristics may include salary, income, job requirements or other descriptive job characteristics). Depending on the implementation, the BDE categorization processing may be sponsor driven 417 (e.g., with the sponsor providing various groupings or tags for BDEs) or system driven 418 (e.g., the CAN system parses a BDE and generates tags or uploads existing BDE tags from a data entry host entity).

Another step involves establishing the sponsor subscription parameters (which may then be used to correlate one or more advertisement distribution parameters). In an implementation, the sponsor distribution parameters include BDE subscription/campaign parameters 420. For example, a sponsor is able to designate certain BDEs that are hosted by the data entry host for selection and distribution as advertisements. Sponsors may agree to pay a fee in exchange for assurances that their BDEs will be distributed (and/or displayed) a certain number of times, over a certain period of time. In some embodiments, a sponsor may also establish distribution parameters that affect the selection of underlying BDEs for distribution to target web users.

In order to establish subscription parameters, a sponsor may interact with the CAN system (or a system administrator) to view registered affiliate reports 433 (as illustrated in FIG. 4B), visitor data reports 430 (as illustrated in FIG. 4C) and/or affiliate web site maps/content characteristics 436. Advantageously, the sponsor independently or with the assistance of a system administrator may designate certain affiliates as distribution targets for their selected BDEs. In an implementation, the designation process may be supplemented by historical CAN system data analysis.

The sponsor may also establish an ad distribution scope 426. More specifically, the sponsor can determine how they want to prioritize the level of granularity associated with the target affiliate/content providers. For example, a sponsor may designate a system defined broad collection of computer programming web site content providers/affiliates as for a course ad distribution 440. Alternately, the sponsor may select a specific Java programming news web site as distribution targets 445. In a premium campaign, the sponsor may elect to pursue distribution at a granular level. By way of example only, after viewing affiliate data reports, the sponsor may designate whether they want coarse 440 or granular content provider distribution. Also, by way of example only, the sponsor can indicate they want to distribute their advertisements to a web site that is a forum or weblog for discussions about programming for linux operating systems 445, as opposed to general computer programming discussions.

Similarly, the sponsor may designate a demographic distribution scope 429 of a target demographic. In order to try to fill a software engineering job position, a sponsor may elect to fulfill a certain number of distributions/impressions directed to granular targets 445 instead of coarse targets 440 (e.g., distributing advertisements to affiliates that have identified a web user whose registration data indicates they have a Master's degree in Computer Science 445, as opposed to an affiliate identifying a web user as someone who accessed an affiliate web page discussing general personal computer peripherals 440.

FIG. 4B illustrates aspects of affiliate web site data reports that a sponsor may view in determining sponsor distribution/subscription parameters according to an implementation of the CAN system. By way of example only, the sponsor may view data reports about classes of affiliates and/or content providers 463, as well as characteristics associated with individual affiliates/content providers. Some of the individual affiliate/content provider characteristics may include various visitor metrics 465, such as the number of registered users 467, total/average web site traffic for registered/anonymous users broken down by a periodic duration (e.g., monthly/weekly/daily/hourly visitor traffic data) 469; a registered user retention rate (e.g., how many times a particular registered user returns over a given period of time) 471; and/or the rate of new registrations for a given period of time 473.

Additional affiliate/content provider characteristics may include types of cataloged historical visitor data 475, as well as individual visitor data records (as illustrated and discussed with regard to FIG. 4C). The affiliate report may include examples of the types of visitor registration data 477; affiliate specific information derived with the web user's authorization from web user/affiliate interaction such as resume/employment history data 479; web user survey data 481; a web user's content provider searching history 483; and/or a content provider page access history 485.

In some implementations, the affiliate/content provider may provide a content distribution map 487 providing an overview of the various types/categories of content associated with their site, as well as how the web site is set up. These maps may be useful to sponsors who are attempting to determine the sponsor distribution scope 426. A sponsor may visualize how many clicks a web user would need to execute to reach the content that the sponsor is interested in. For example, a sponsor who wants to place software engineering job advertisements may determine that web user takes may access the software engineering discussion forum directly from the content provider's home page. In some implementations, the content distribution maps may be complemented with traffic distribution maps that illustrate average, total periodic, and/or peak traffic flows across the content provider's web site 488.

Another example, of an affiliate distribution parameter relates to the content provider indicators that specify the types of advertisements that the content provider/affiliate is capable of supporting 489. For example, a content provider may indicate that they can accommodate pop-up, pop-overs and web banner advertisements. The content provider may also provide display/formatting specifications as part of establishing the content provider distribution parameters.

FIG. 4C illustrates aspects of an affiliate visitor report 490. These types of reports may be based on data of anonymous web users who have accessed a content provider. Alternately, the report may be based on data that web users have authorized content provider/affiliate 493 to collect and transfer to the CAN system related to web user interaction data. Accordingly, the system enables a sponsor 491 to access the reports 490 through advertisement server 492. As such, the sponsor 491 may make distribution decisions based on various types of web user characteristic data 494a-n during the base data entry selection/targeting process. In some implementations, sponsors 491 (e.g., employers with job listings) can review various categories of content provider's web user characteristics and select a group of web users to designate as target web users. Accordingly, if the web user is identified, the web user. For example, a sponsor searches a content provider's visitor data may be achieved using keywords and a search engine. As shown in the figure, site visitor data 494a-n may be stored by the affiliate content server 492. However, the amount of information known about the various site visitors is not uniform, as represented by the different sizes of the site visitor data files. So, for example, more information is known about site visitor 494A than is known about site visitor 494F. As such, the sponsor's established distribution demographic scope becomes an important aspect of the targeting process that may be customized to meet the needs of the sponsor.

With this collection of information, a sponsor can opt to display ads only to site visitors with a certain level of known characteristic or with particular known characteristic. For example, an advertiser might only want his ads shown to people working in information technology and living in or around Austin, Tex., or only displayed to web users with known levels of education, such as college graduates or PhDs. In some implementations, the CAN system may be configured to price distribution ads based upon the level of details known about a particular web site visitor. For example, a sponsor might buy fewer, more expensive, narrowly targeted ads; alternately, the sponsor could buy a larger number of cheaper less targeted ads.

In another implementation of the system, the affiliate content provider might choose the amount of site visitor information they would like to provide to the advertisement server. In addition to allowing web users to authorize data collection/transfer, this method allows a content provider to address any web user's privacy concerns. Another aspect of system involves providing compensation (e.g., a portion of revenue generated by the sales of distribution advertisements) provided to the affiliate/content provider. In an implementation, the portion of revenue may be based upon the amount of information about the site visitor provided. In this way, affiliate content providers can be rewarded by providing more information, which results in more effective ad selection and placement. If an affiliate content provider would like to provide reduced information about their site visitors, they can receive broader less profitable ads.

In an implementation, the affiliate may create a web user record as a user interacts with the affiliate/content provider web site. The data record may be created at the request of the web user during active web user interaction 505 or passive web user interaction 525 (e.g., web site records an anonymous non-registered user's search history and identifies future interaction by placing a cookie on the user's terminal). In an active interaction implementation, the web user may actively provide user-identifying characteristic data during a web site registration process 510.

Depending on the implementation, the affiliate may limit the availability of certain user data (e.g., associating only zip code, gender, general age group information with an anonymous user id, while maintaining the user's name, mailing address in strict confidence). The system may also be configured to create a web user data record during web user interaction. For example, a web site may be configured to utilize user information extracted during user surveys, or during processing uploaded resumes or other types of user provided data characteristics. In some implementations, the web user may be requested to approve the collection and distribution of the collected data to the CAN system. The Affiliate may upload user data to the CAN after identifying a registered (or non-registered anonymous user) 520. Depending on the implementation, the data may be uploaded as part of an ad request or at certain intervals after a user visits (or re-visits) the affiliate web site.

Some implementations may be configured to facilitate passive interaction data collection and distribution 525. Two of the many ways passive data collection and processing may be effectuated through the distribution of cookies 530. Affiliates may agree to distribute cookies so that if and when a web user with a particular type of content provider cookie accesses the base data entry host 545 (e.g., a registered user for a new web site visits a job employment site, the job site collects affiliate/web user interaction data 545). Another example involves collecting web user/content provider interaction data based on a cookie placed on the web user's terminal each time the web user accesses the content provider (e.g., as the web user conducts searches on a content provider, the content provider collects interaction data).

The active/passive interaction data 520, 545, 550 is then transmitted to the CAN system for aggregation into a CAN system database. In the event that the user is a non-registered user, the system may be configured to determine whether the non-registered user data matches any stored anonymous user data records 560. The CAN system then processes and manages the user data associated with both registered and anonymous non-registered users 565. Depending on the implementation and the scope of the collected user data, the system may be configured to coordinate a variety of a data management tasks, such as grouping similar user data records together and/or creating varying levels of group descriptors (e.g., technology characteristics, computer characteristics, computer programming characteristics, java programming characteristics, etc. . . . ) 570.

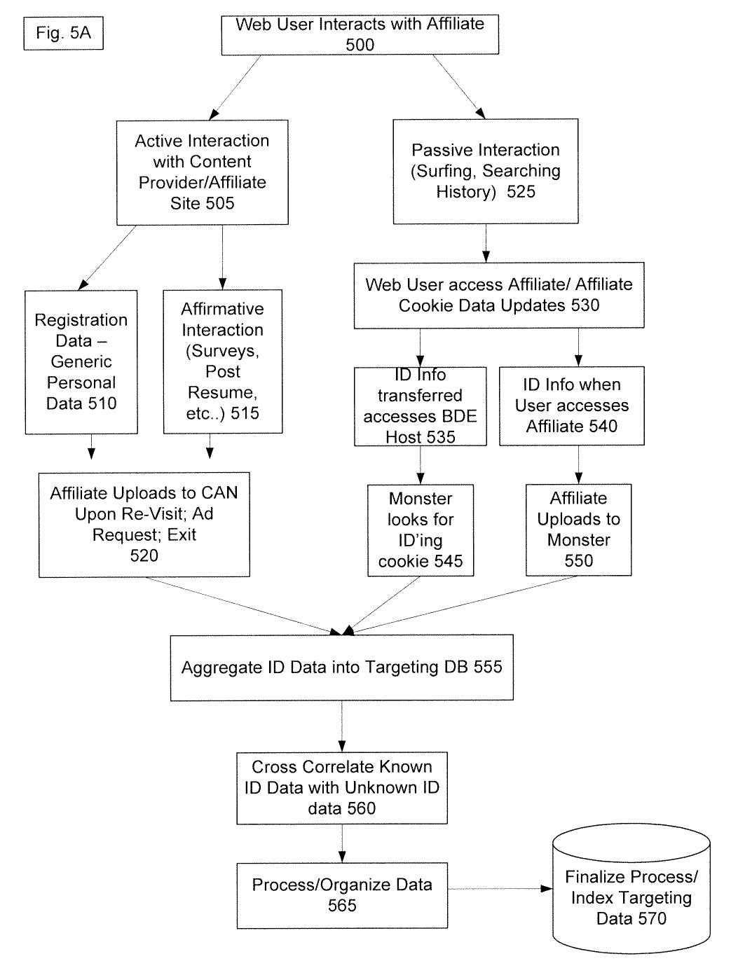

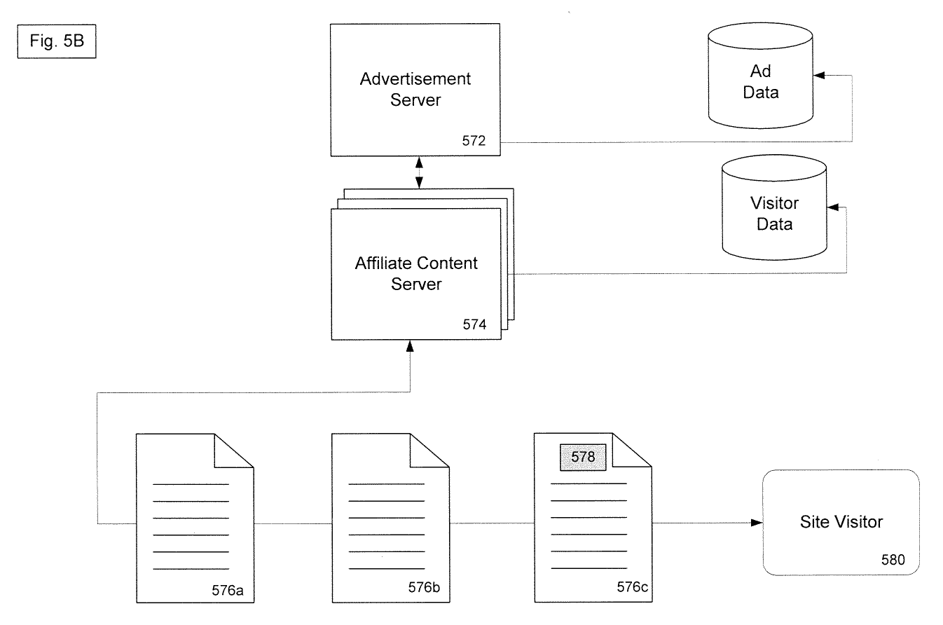

FIG. 5B illustrates an embodiment for the placement of ads through the interaction of the advertisement server 572 and an affiliate content server 574. In this embodiment, one or more affiliate content servers 574 request ad serving from the advertisement server 572. The request may include stored or categorical information about the site visitor 580 from the visitor data store 573. The information about the site visitor 580 could have come from a number of sources.

For example, the site visitor information could have been derived during the current web content session/interaction between the affiliate content server and the site visitor, such as information derived from the site visitors viewing and interaction with affiliate content pages 576a and 576b. Or, it could come from information received and stored during the site visitor's previous interactions with the affiliate content server. In addition, two or more different affiliate content servers might share or combine their saved site visitor data.

Site visitor data might also have been previously stored by the advertisement server. For example the site visitor data might be associated with a site visitor identifier, e.g., a cookie, the advertisement server might keep data indicating visitor characteristics associated with the identifier. In this way, the advertisement server can correlate information about the site visitor that was previously provided by one or more affiliate content servers and the advertisement server can track which ads were of interest to the site visitor. For example, if the site visitor had previously clicked on ads for java programmers, the advertisement server will have a highly relevant data point to indicate that programming jobs are of interest to that visitor.

In one embodiment, the site visitor's use of the affiliate content server service results in information about the site visitor being provided to the affiliate content server. For example, the affiliate content server may provided personality tests, skills evaluations, I.Q. tests, career recommendations, etc., such as the tests provided at tickle.com. When the site visitor uses the affiliate content server, information about himself or herself is gathered. In another example, the site visitor may have filled out a user profile that provides detailed information about him or herself.

In another example, the affiliate content server may provide social or business networking services, such as myspace.com or linkedin.com. In using such a service, the site visitor may create a web page providing details about the users skills and interests. In another example, the affiliate content server may provide career services like monster.com. In using the service the site visitor may have uploaded a resume or created a user profile that indicates the user's skill set, educational background, work experience, interests, etc. In this way, it can be seen that the affiliate content server and the listings server may be one in the same entity.

Regardless of the mechanism in which information about the site visitor is recorded. Some or all of the recorded information is provided by the affiliate content server 574 to the advertisement server 572. In addition, information about the site visitor might be added based on context of the affiliate content site or added by categorizing the affiliate content site itself. In other words, a particular affiliate content site might indicate for itself that particular characteristics apply to all of its site visitors, or this determination may be made by the operators of the advertisement server. For example, an affiliate content site directed to semiconductor industry news might set forth that all of its site visitors are involved in the semiconductor industry. Or, the advertisement server might make that determination. In addition, the affiliate content server operator may want to have more control over the companies and types of ads that are displayed on its site and could set characteristics accordingly. For example, an affiliate content site devoted to alternative energy might want to exclude advertisements from oil companies.

Once the characteristics for a particular site visitor are received and gathered by the advertisement server, the advertisement server can use this information to retrieve an ad from the ad data store 573 and provide an advertisement that is narrowly targeted to suit the site visitor. The search for an ad targeted to the site visitor in question can be accomplished by database searches over the ad data store and associated matching algorithms. For example, if the affiliate content server provides the advertisement server with three facts about the site visitor, the advertisement server can search the ad data store for ads that most closely match the provided criteria. Any discovered ad 578 can then be inserted into content page 576c and presented to the site visitor by the affiliate content server 574.

If multiple matching ads are discovered, multiple ads can be shown to the site visitor or the ads can be narrowed down based on additional criteria, such as the amount of revenue generated by the ad, the amount of time since the ad was last displayed, etc. The number of ads displayed to the site visitor may be determined by the number of ad positions made available by the affiliate content server. If the number of relevant ads matching the site visitor is less than the number of available ads, the extra ad space can be filled in with broad based ads or ads driving traffic for the system as a whole. For example, ads might drive traffic to the original listing service, e.g., the job listing server.

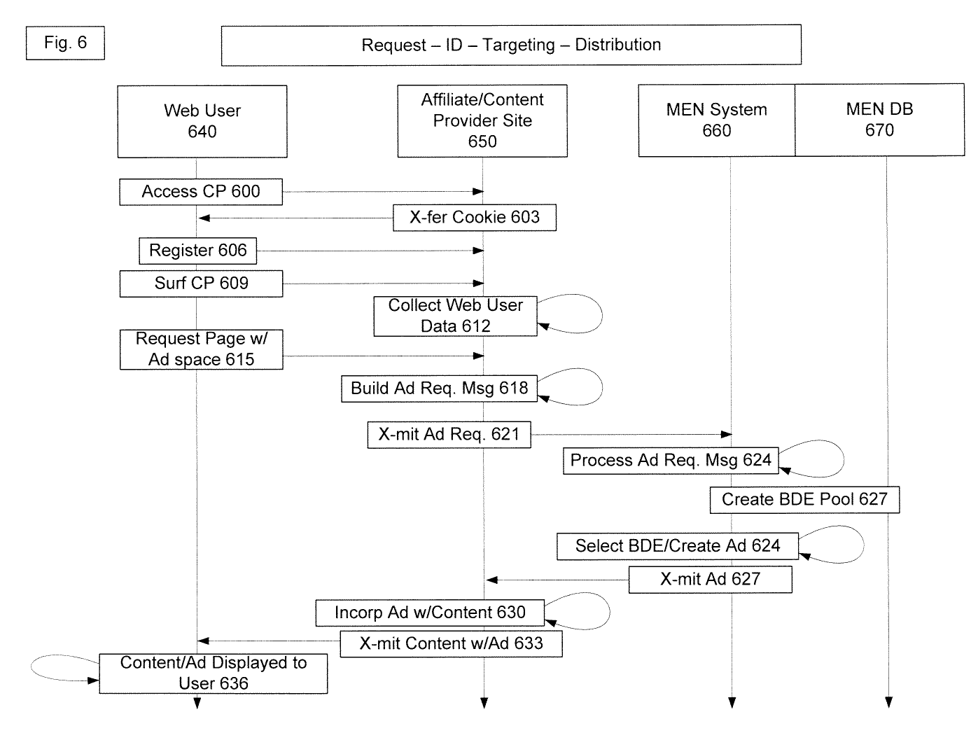

FIG. 6 illustrates an flow diagram associated with ad targeting according to another implementation of the system. Web user 640 attempts to access content provider 600. In a passive data collection implementation, the content provider 650 may transfer a cookie 603 to the web user's terminal 640. The system may also implement aspects of an active data collection implementation—e.g., the web user 640 may register with the content provider 606. After the registration, the web user may navigate through various pages associated with the content provider's web site 609. As the web user navigates through the various pages, the content provider collects data associated with items of interest, advertisements displayed to the web user, content (and/or categories of content) provided to the web user.

As part of the user's navigation, the user may click a link for a particular page (or type of content) (e.g., requesting a computer programming news front page) 615. As part of creating the page and responding to the web user, the content provider 650 accesses content provider databases 670 to retrieve the requested content, the content provider may then create an ad request message 618 (described in greater detail with regard to FIG. 7A) and transmit the ad request message 621 to the CAN system 660. The CAN System 660 receives and processes the Ad request message 624 and creates a potential BDE pool 627 (described in greater detail with regard to FIG. 7B). The CAN system then selects the underlying BDE from the pool 624, creates the distribution advertisement and transmits it back to the Content Provider 627 for incorporation with the web user's requested content 630. The requested content with the incorporated advertisement is then transmitted from the content provider to the web user 633, where it is displayed to the web user 636. In some implementations, the ad request message may include content destination address parameters, as such the advertisement may be created by the CAN system and transmitted to the web user terminal for incorporation with the requested content from the content provider.

FIG. 7A illustrates aspects of an implementation of the distributed advertisement request message generation process. The Content Provider receives a request for certain content from a web user 700 (e.g., the web user may have clicked on a link at the Content Provider's web site). The content provider (or affiliate) may retrieve their content, as well as create an ad request message that is transmitted to the CAN requesting an distribution advertisement for incorporation with their content. The ad request message is populated differently base on whether the requesting Content Provider/Affiliate is registered with the CAN system 710.

If the Content Provider is not registered or is implementing in a limited trial version of the CAN System, the Ad creation process may initiate a registration process for the Content Provider 712. Also, the in this implementation, the Content Provider may be requested to provide a general data descriptor 714 that provides a high-level description of the types of content that the Content Provide provides to web user. The general data descriptor is used to populate the ad request message, which is then transmitted to the CAN system as a request for a default distribution ad 716 (e.g., the CAN may determine that requesting entity is a content provider directed to new broadcasting and request an underlying BDE from a related field, such as a journalism job opportunity).

A registered Content Provider (or one implementing a full trial version of the system) populates the ad request message with a variety of Content Provider Distribution Parameters 715. For example, a registered Content Provider may simply provide a Content Provider ID and/or an ad specification ID 720 (as described below, these parameters are may be used by the CAN system to correlate various stored Content Provider and/or advertisement characteristics, such as Content Provider descriptors, advertisement specification formats or any other number of CAN system stored content provider characteristics used during the BDE selection and/or Ad creation process). The Content Provider may provide additional content category data 725 (e.g., a computer news web site, may provide various data related to the general type of content requested by a user, such as-Personal Computer News stories). In some implementations, this data may be further supplemented by a descriptor related to the specific content being requested 730 (e.g., a specific news story about the latest personal computer CPU).

Once the Content Provider distribution characteristics have been populated, the Content Provider may incorporate web user data about the web user into the ad request message 735. If no web user data exists the ad request is based primarily on the Content Provider distribution characteristics, as the Content Provider prepares a request for the distribution ad 740. The Content Provider may have a variety of identified web user data, for example the Content Provider may have active 742 or passive 743 web user interaction data. For example, the Content Provider may populate the ad request with the web id 744 associated with a registered web user collected during a registration process, or during content provider/web user interaction (e.g., an id that the CAN system may use to access a variety of user characteristics that have been previously uploaded to the CAN system). In another example, the Content Provider may populate the ad request message with collected dynamic web user data (e.g., cookie data collected from an anonymous web user during interaction with the Content Provider). In other implementations, the ad request message may be configured to include a wide variety of other distribution parameters that may be used by the CAN in selecting the BDE for distribution as an advertisement. Once the ad request message is populated, the Content Provider finalizes and transmits the Ad Request message to the CAN system.

FIG. 7B illustrates aspects of the CAN system processing an ad request message and selecting an underlying BDE for distribution as an online advertisement. The CAN system receives the ad request message from the Content Provider/Affiliate 750. The CAN system determines whether the requesting Content Provider is a registered content provider 755. If the requesting content provider is a registered content provider, the CAN system extracts content provider distribution characteristics 757. The CAN system may be configured to extract a Content Provider ID, which may be correlated to a wide of a Content Provider distribution characteristics that are stored during a registration process and/or through ongoing data updates.

For example, the Content Provider ID may be correlated with ad formatting specification 759, Content Provider content descriptors 761 such as, technology news, computer news, etc. . . . , content descriptors related to the specific web user requested content 763 such as, a descriptor about the requested link or news article. In some implementations, the CAN system may be configured to extract these or other distribution parameters that the Content Provider uses to populate the ad request message (instead of being stored on the CAN system and correlated to the Content Provider ID). These and other distribution parameters may be used to identify a number of potential BDEs that are used to create a BDE distribution pool 769.

For example, if Content Provider descriptor 761 indicates the content provider is involved in computer programming news and that the web user requested content is a link to an article discussing a new java programming technique. The BDE distribution pool may be created to contain twenty-five BDEs related to computer programming employment opportunities. In an implementation, the CAN system may implement a scaling module, in which the distribution pool may be sub-divided into granular groups of BDEs, such as Java programming opportunities, AJAX programming opportunities, or other sub-groups.

If the Content Provider is not a registered affiliate 755, the CAN system may analyze the requesting entity 765 (e.g., by retrieving content provider characteristics from a CAN maintained content provider database, by extracting a general content provider descriptor from the ad request message or a number of other processes). For the un-registered Content Provider, the CAN system may derive a general distribution pool 767. For example, if the Content Provider does not have an Content Provider ID with stored characteristics and/or was not able to populate an ad request message, the CAN system may determine that the Content Provider is in a computer related industry by analyzing the requesting address (e.g., wwwjavacomputernews.com) and create a general distribution pool that includes twenty-five computer industry job opportunities.

Once the BDE distribution pool has been created, the CAN system determines whether the ad request message includes web user data 771. If the ad request message does not include web user data, the CAN System selects a BDE from the distribution pool base on sponsor subscription characteristics associated with the BDEs in the pool. In contrast, if the CAN system extracts a web user data record 773, the system retrieves web user characteristics from the CAN system database. The CAN system may analyze a user data record (if one exists) 775, user data extracted from the ad request message 777 (web user cookie data) or some combination of the two. The user data is then used to adjust the BDE pool 779 (e.g., add, delete, or substitute BDEs with BDEs from the pool). In an example, the CAN system may retrieve a data record that indicates an identified web user is (or has been) a Java programmer. This information may be used to delete non-java programming opportunities from the BDE distribution pool. Further, the CAN system may be configured to retrieve additional BDEs that related to Java programming opportunities to supplement the BDE pool.

After the contents of the BDE pool is adjusted, the CAN system may conduct an initial ranking of the BDEs in the distribution pool according to a number of factors 779. For example, the content provider distribution characteristics, the web user characteristics, or some combination of the two may be used to create a ranking of BDEs based on their relevance to the content provider and/or the web user. Further, the system may utilize BDE sponsor data to refine the initial rankings. If web user data does not exist, the CAN system may derive a ranking based on the content provider's and/or the sponsor's distribution parameters. In an example, the initial system derived BDE ranking 779 may be reordered to fulfill sponsor distribution specifications 781, (e.g., if a BDE in the distribution pool is designated as a premium weighted BDE, it may be selected for distribution before regular subscription BDEs). In another example, if the BDE pool includes a BDE that must be distributed in order to fulfill a sponsor's distribution or impression quota, it may be selected for distribution over BDEs that may have more relevant subject matter. These implementations facilitate balancing distributing advertisements that are particularly relevant to a content provider, a web user or both, as well as meeting the distribution requirements associated with a particular sponsor's underlying BDEs. Once the balancing is achieved, the CAN system selects the BDE and transfers it to the an Ad creation module associated with the CAN system 783.

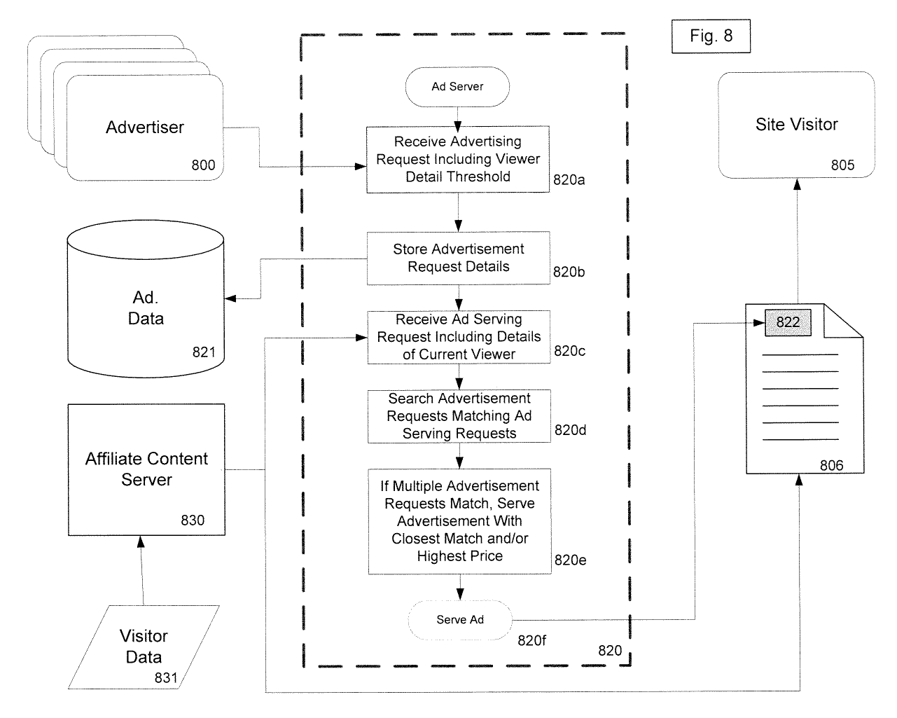

FIG. 8 shows an exemplary process and flow diagram for ad serving in accordance with the disclosed system. One or more advertisers 800 submit a request for advertising, which is received by the ad server 820a. Along with the request, the advertiser may include information indicating the site visitor criteria identifying preferred candidates for the advertisement and the amount the advertiser is willing to pay. In the alternative, the relevant site visitor criteria can be extracted from the content of the listing. The advertiser might also have specific requests. The advertiser, for example, may require that the ad is only shown to site visitors in a particular geographical region or with a specific education level. Or, the advertiser might simply indicate that its ads should only be displayed to site visitors that match a certain number of its listing criteria. For example, the advertiser might choose a level where the ad is only shown to site visitors that match three or more criteria relevant to its offer. The ad server can then store the advertisement request details 820b in the ad data store 821.

An affiliate content server 830 will interact with the ad server to request ads to be displayed in the affiliate content server's content pages 806. The affiliate content server 830 will display its content to site visitor 805. In interacting with the site visitor, or through previous interactions with the site visitor, the system develops site visitor data 831. The site visitor data 831 may be passed to the ad server along with the request for ad serving. Upon receipt of the ad serving request 820c, the ad server searches 820d the ad data 821 for ads matching the request, including any supplied visitor data. If multiple potentially matching ads are discovered in the search, the ads with the highest price and/or the closest match to the submitted data are served 820e. If only one ad is discovered, that ad is served. The ad to be served 821 is inserted into the affiliated content server's content page 806. This can be done directly by the ad server 820 or the ad could be provided to the affiliate content server for insertion into the content.

In an alternative embodiment, instead of using pre-generated ads stored in the ad data store, the advertisement server may directly search the job listings data store for relevant job listings. If a job listing matching the ad request is discovered, an ad can be automatically generated using the ad generation techniques described above. The ad can then be inserted into the content displayed to the site visitor. In such system the ad data store could either be eliminated or it could be used to store details regarding the advertisers' requests, budgets, criteria, and ad pricing.

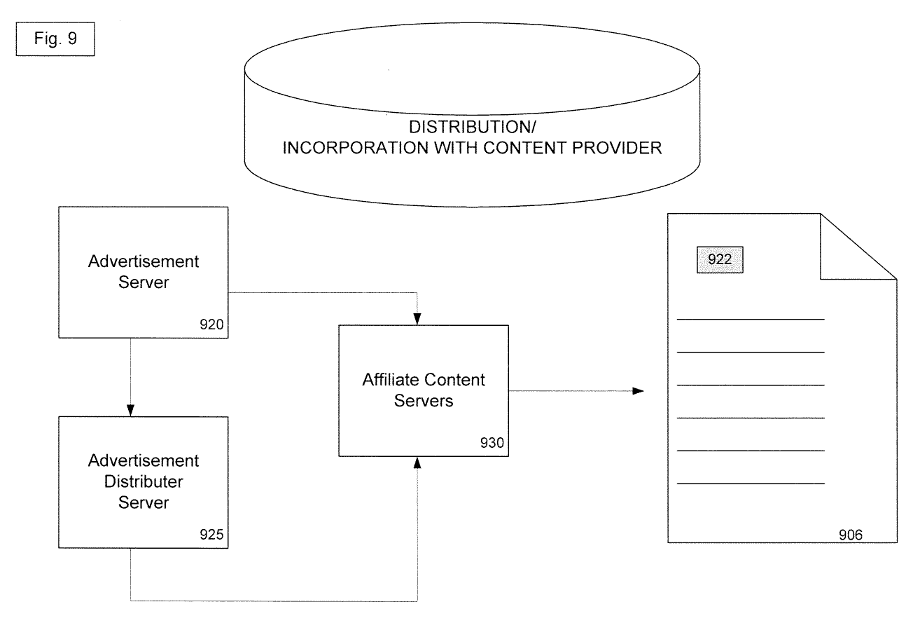

FIG. 9 illustrates an embodiment disclosing advertisement distribution in accordance with another aspect of the disclosed system. As shown in the figure, advertisement server 920 is in communication with affiliate content servers 930 and advertisement distribution server 925. The affiliate content server displays site content pages 906. The figure demonstrates a number of methods for distributing ads 922 to the affiliate content server. In one embodiment the advertisement is passed from the advertisement server directly to the affiliate content server. It should be noted that ad could either be delivered as the content of the ad itself or it can be delivered as a symbolic link to the ad content. In another embodiment the ads can be served by a dedicated advertisement distribution server, which might be embodied by an existing commercial ad distribution network. In this way, the advertisement server can take advantage of large commercial distribution networks and have access to affiliate content serves that would like to source their advertisements through such a provider.

Targeting/Distribution Advertisement Engine Controller

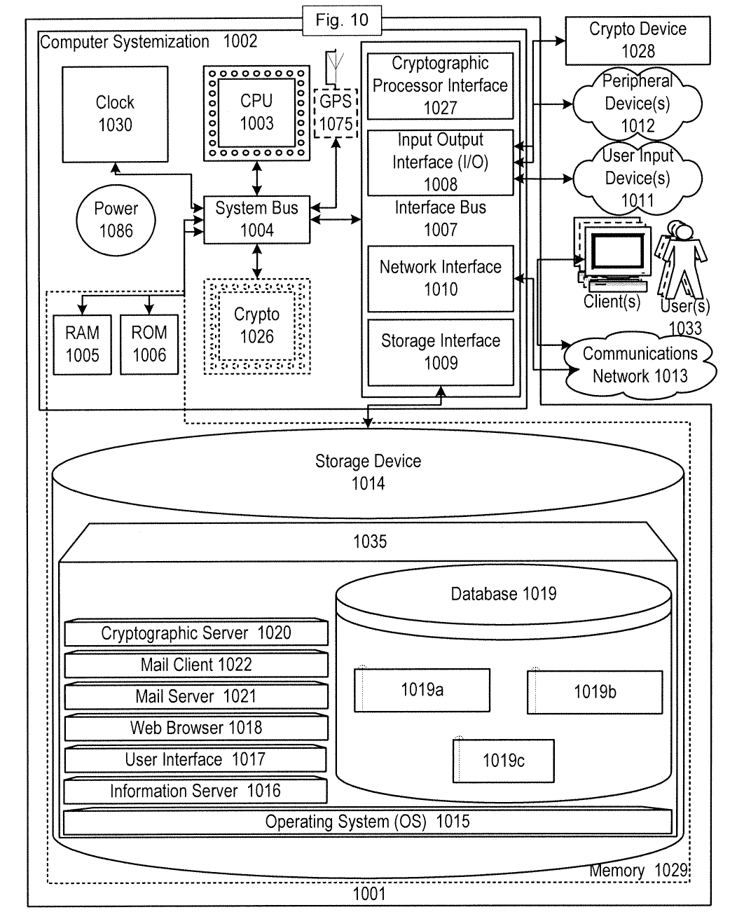

The advertisement server and generators described above can be embodied by an targeting/distribution advertisement engine (“Engine”) controller 1001. FIG. 10 of the present disclosure exhibits illustrates inventive aspects of the Engine controller 1001 in a block diagram. In this embodiment, the Engine controller 1001 may serve to generate, manage, price, sell, match, display, serve, and distribute advertisements.

Computers employ processors to process information; such processors are often referred to as central processing units (CPU). A common form of processor is referred to as a microprocessor. A computer operating system, which, typically, is software executed by CPU on a computer, enables and facilitates users to access and operate computer information technology and resources. Common resources employed in information technology systems include: input and output mechanisms through which data may pass into and out of a computer; memory storage into which data may be saved; and processors by which information may be processed. Often information technology systems are used to collect data for later retrieval, analysis, and manipulation, commonly, which is facilitated through database software. Information technology systems provide interfaces that allow users to access and operate various system components.

In one embodiment, the Engine controller 1001 may be connected to and/or communicate with entities such as, but not limited to: one or more users from user input devices 1011; peripheral devices 1012; a cryptographic processor device 1028; and/or a communications network 1013.

Networks are commonly thought to comprise the interconnection and interoperation of clients, servers, and intermediary nodes in a graph topology. It should be noted that the term “server” as used throughout this disclosure refers generally to a computer, other device, software, or combination thereof that processes and responds to the requests of remote users across a communications network. Servers serve their information to requesting “clients.” The term “client” as used herein refers generally to a computer, other device, software, or combination thereof that is capable of processing and making requests and obtaining and processing any responses from servers across a communications network. A computer, other device, software, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The Engine controller 1001 may be based on common computer systems that may comprise, but are not limited to, components such as: a computer systemization 1002 connected to memory 1029.

Computer Systemization

A computer systemization 1002 may comprise a clock 1030, central processing unit (CPU) 1003, a read only memory (ROM) 1006, a random access memory (RAM) 1005, and/or an interface bus 1007, and most frequently, although not necessarily, are all interconnected and/or communicating through a system bus 1004. Optionally, the computer systemization may be connected to an internal power source 1086. Optionally, a cryptographic processor 1026 may be connected to the system bus. The system clock typically has a crystal oscillator and provides a base signal. The clock is typically coupled to the system bus and various clock multipliers that will increase or decrease the base operating frequency for other components interconnected in the computer systemization. The clock and various components in a computer systemization drive signals embodying information throughout the system. Such transmission and reception of signals embodying information throughout a computer systemization may be commonly referred to as communications. These communicative signals may further be transmitted, received, and the cause of return and/or reply signal communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

Power Source

The CPU comprises at least one high-speed data processor adequate to execute program modules for executing user and/or system-generated requests. The CPU may be a microprocessor such as AMD's Athlon, Duron and/or Opteron; IBM and/or Motorola's PowerPC; Intel's Celeron, Itanium, Pentium, Xeon, and/or XScale; and/or the like processor(s). The CPU interacts with memory through signal passing through conductive conduits to execute stored program code according to conventional data processing techniques. Such signal passing facilitates communication within the Engine controller and beyond through various interfaces. Should processing requirements dictate a greater amount speed, parallel, mainframe and/or super-computer architectures may similarly be employed. Alternatively, should deployment requirements dictate greater portability, smaller Personal Digital Assistants (PDAs) may be employed.

The power source 1086 may be of any standard form for powering small electronic circuit board devices such as the following power cells: alkaline, lithium hydride, lithium ion, nickel cadmium, solar cells, and/or the like. Other types of AC or DC power sources may be used as well. In the case of solar cells, in one embodiment, the case provides an aperture through which the solar cell may capture photonic energy. The power cell 1086 is connected to at least one of the interconnected subsequent components of the Engine thereby providing an electric current to all subsequent components. In one example, the power source 1086 is connected to the system bus component 1004. In an alternative embodiment, an outside power source 1086 is provided through a connection across the I/O 1008 interface. For example, a USB and/or IEEE 1394 connection carries both data and power across the connection and is therefore a suitable source of power.

Interface Adapters

Interface bus(ses) 1007 may accept, connect, and/or communicate to a number of interface adapters, conventionally although not necessarily in the form of adapter cards, such as but not limited to: input output interfaces (I/O) 1008, storage interfaces 1009, network interfaces 1010, and/or the like. Optionally, cryptographic processor interfaces 1027 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 1009 may accept, communicate, and/or connect to a number of storage devices such as, but not limited to: storage devices 1014, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 1010 may accept, communicate, and/or connect to a communications network 1013. Through a communications network 1013, the Engine controller is accessible through remote clients 1033b (e.g., computers with web browsers) by users 1033a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 1010 may be used to engage with various communications network types 1013. For example, multiple network interfaces may be employed to allow for the communication over broadcast, multicast, and/or unicast networks.

Input Output interfaces (I/O) 1008 may accept, communicate, and/or connect to user input devices 1011, peripheral devices 1012, cryptographic processor devices 1028, and/or the like. I/O may employ connection protocols such as, but not limited to: Apple Desktop Bus (ADB); Apple Desktop Connector (ADC); audio: analog, digital, monaural, RCA, stereo, and/or the like; IEEE 1394a-b; infrared; joystick; keyboard; midi; optical; PC AT; PS/2; parallel; radio; serial; USB; video interface: BNC, coaxial, composite, digital, Digital Visual Interface (DVI), RCA, RF antennae, S-Video, VGA, and/or the like; wireless; and/or the like. A common output device is a television set, which accepts signals from a video interface. Also, a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Typically, the video interface provides the composited video information through a video connection interface that accepts a video display interface (e.g., an RCA composite video connector accepting an RCA composite video cable; a DVI connector accepting a DVI display cable, etc.).

User input devices 1011 may be card readers, dongles, finger print readers, gloves, graphics tablets, joysticks, keyboards, mouse (mice), remote controls, retina readers, trackballs, trackpads, and/or the like.

Peripheral devices 1012 may be connected and/or communicate to I/O and/or other facilities of the like such as network interfaces, storage interfaces, and/or the like. Peripheral devices may be audio devices, cameras, dongles (e.g., for copy protection, ensuring secure transactions with a digital signature, and/or the like), external processors (for added functionality), goggles, microphones, monitors, network interfaces, printers, scanners, storage devices, video devices, video sources, visors, and/or the like.

It should be noted that although user input devices and peripheral devices may be employed, the Engine controller may be embodied as an embedded, dedicated, and/or monitor-less (i.e., headless) device, wherein access would be provided over a network interface connection.

Cryptographic units such as, but not limited to, microcontrollers, processors 1026, interfaces 1027, and/or devices 1028 may be attached, and/or communicate with the Engine controller. A MC68HC16 microcontroller, commonly manufactured by Motorola Inc., may be used for and/or within cryptographic units. Equivalent microcontrollers and/or processors may also be used. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Other commercially available specialized cryptographic processors include VLSI Technology's 33 MHz 6868 or Semaphore Communications' 740 MHz Roadrunner.

Memory

Generally, any mechanization and/or embodiment allowing a processor to affect the storage and/or retrieval of information is regarded as memory 1029. However, memory is a fungible technology and resource, thus, any number of memory embodiments may be employed in lieu of or in concert with one another. It is to be understood that the Engine controller and/or a computer systemization may employ various forms of memory 1029. For example, a computer systemization may be configured wherein the functionality of on-chip CPU memory (e.g., registers), RAM, ROM and any other storage devices are provided by a paper punch tape or paper punch card mechanism; of course such an embodiment would result in an extremely slow rate of operation. In a typical configuration, memory 1029 will include ROM 1006, RAM 1005, and a storage device 1014. A storage device 714 may be any conventional computer system storage. Storage devices may include a drum; a (fixed and/or removable) magnetic disk drive; a magneto-optical drive; an optical drive (i.e., CD ROM/RAM/Recordable (R), ReWritable (RW), DVD R/RW, etc.); and/or other devices of the like. Thus, a computer systemization generally requires and makes use of memory.

Module Collection

The memory 1029 may contain a collection of program and/or database modules and/or data such as, but not limited to: operating system module(s) 1015 (operating system); information server module(s) 1016 (information server); user interface module(s) 1017 (user interface); Web browser module(s) 1018 (Web browser); database(s) 1019; cryptographic server module(s) 1020 (cryptographic server); the Engine module(s) 1035; and/or the like (i.e., collectively a module collection). These modules may be stored and accessed from the storage devices and/or from storage devices accessible through an interface bus. Although non-conventional software modules such as those in the module collection, typically, are stored in a local storage device 1014, they may also be loaded and/or stored in memory such as: peripheral devices, RAM, remote storage facilities through a communications network, ROM, various forms of memory, and/or the like.

Operating System

The operating system module 1015 is executable program code facilitating the operation of the Engine controller. Typically, the operating system facilitates access of I/O, network interfaces, peripheral devices, storage devices, and/or the like. The operating system may be a highly fault tolerant, scalable, and secure system such as Apple Macintosh OS X (Server), AT&T Plan 9, Be OS, Linux, Unix, and/or the like operating systems. However, more limited and/or less secure operating systems also may be employed such as Apple Macintosh OS, Microsoft DOS, Palm OS, Windows 2000/2003/3.1/95/98/CE/Millenium/NT/XP (Server), and/or the like. An operating system may communicate to and/or with other modules in a module collection, including itself, and/or the like. Most frequently, the operating system communicates with other program modules, user interfaces, and/or the like. For example, the operating system may contain, communicate, generate, obtain, and/or provide program module, system, user, and/or data communications, requests, and/or responses. The operating system, once executed by the CPU, may enable the interaction with communications networks, data, I/O, peripheral devices, program modules, memory, user input devices, and/or the like. The operating system may provide communications protocols that allow the Engine controller to communicate with other entities through a communications network 1013. Various communication protocols may be used by the Engine controller as a subcarrier transport mechanism for interaction, such as, but not limited to: multicast, TCP/IP, UDP, unicast, and/or the like.

Information Server

An information server module 1016 is stored program code that is executed by the CPU. The information server may be a conventional Internet information server such as, but not limited to Apache Software Foundation's Apache, Microsoft's Internet Information Server, and/or the. The information server may allow for the execution of program modules through facilities such as Active Server Page (ASP), ActiveX, (ANSI) (Objective-) C (++), C#, Common Gateway Interface (CGI) scripts, Java, JavaScript, Practical Extraction Report Language (PERL), Python, WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), and/or the like. The information server provides results in the form of Web pages to Web browsers, and allows for the manipulated generation of the Web pages through interaction with other program modules. After a Domain Name System (DNS) resolution portion of an HTTP request is resolved to a particular information server, the information server resolves requests for information at specified locations on the Engine controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 1021, and/or the like. An information server may communicate to and/or with other modules in a module collection, including itself, and/or facilities of the like. Most frequently, the information server communicates with the Engine database 1019, operating systems, other program modules, user interfaces, Web browsers, and/or the like.

Access to the Engine database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the Engine. In one embodiment, the information server would provide a Web form accessible by a Web browser. Entries made into supplied fields in the Web form are tagged as having been entered into the particular fields, and parsed as such. The entered terms are then passed along with the field tags which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the Engine as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program module, system, user, and/or data communications, requests, and/or responses.

User Interface

The function of computer interfaces in some respects is similar to automobile operation interfaces. Automobile operation interface elements such as steering wheels, gearshifts, and speedometers facilitate the access, operation, and display of automobile resources, functionality, and status. Computer interaction interface elements such as check boxes, cursors, menus, scrollers, and windows (collectively and commonly referred to as widgets) similarly facilitate the access, operation, and display of data and computer hardware and operating system resources, functionality, and status. Operation interfaces are commonly called user interfaces. Graphical user interfaces (GUIs) such as the Apple Macintosh Operating System's Aqua, Microsoft's Windows XP, or Unix's X-Windows provide a baseline and means of accessing and displaying information graphically to users.

A user interface module 1017 is stored program code that is executed by the CPU. The user interface may be a conventional graphic user interface as provided by, with, and/or atop operating systems and/or operating environments such as Apple Macintosh OS, e.g., Aqua, Microsoft Windows (NT/XP), Unix X Windows (KDE, Gnome, and/or the like), mythTV, and/or the like. The user interface may allow for the display, execution, interaction, manipulation, and/or operation of program modules and/or system facilities through textual and/or graphical facilities. The user interface provides a facility through which users may affect, interact, and/or operate a computer system. A user interface may communicate to and/or with other modules in a module collection, including itself, and/or facilities of the like. Most frequently, the user interface communicates with operating systems, other program modules, and/or the like. The user interface may contain, communicate, generate, obtain, and/or provide program module, system, user, and/or data communications, requests, and/or responses. The user interface may also be configured as one or more advertisement displaying and/or web browsing widgets.

Web Browser

A Web browser module 1018 is stored program code that is executed by the CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Some Web browsers allow for the execution of program modules through facilities such as Java, JavaScript, ActiveX and/or the like. Web browsers and like information access tools may be integrated into PDAs, cellular telephones, and/or other mobile devices. A Web browser may communicate to and/or with other modules in a module collection, including itself, and/or facilities of the like. Most frequently, the Web browser communicates with information servers, operating systems, integrated program modules (e.g., plug-ins), and/or the like; e.g., it may contain, communicate, generate, obtain, and/or provide program module, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the Engine enabled nodes. The combined application may be nugatory on systems employing standard Web browsers.

Cryptographic Server

A cryptographic server module 1020 is stored program code that is executed by the CPU 1003, cryptographic processor 1026, cryptographic processor interface 1027, cryptographic processor device 1028, and/or the like. Cryptographic processor interfaces will allow for expedition of encryption and/or decryption requests by the cryptographic module; however, the cryptographic module, alternatively, may run on a conventional CPU. The cryptographic module allows for the encryption and/or decryption of provided data. The cryptographic module allows for both symmetric and asymmetric (e.g., Pretty Good Protection (PGP)) encryption and/or decryption. The cryptographic module may employ cryptographic techniques such as, but not limited to: digital certificates (e.g., X.509 authentication framework), digital signatures, dual signatures, enveloping, password access protection, public key management, and/or the like. The cryptographic module will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the Engine may encrypt all incoming and/or outgoing communications and may serve as node within a virtual private network (VPN) with a wider communications network. The cryptographic module facilitates the process of “security authorization” whereby access to a resource is inhibited by a security protocol wherein the cryptographic module effects authorized access to the secured resource. In addition, the cryptographic module may provide unique identifiers of content, e.g., employing and MD5 hash to obtain a unique signature for an digital audio file. A cryptographic module may communicate to and/or with other modules in a module collection, including itself, and/or facilities of the like. The cryptographic module supports encryption schemes allowing for the secure transmission of information across a communications network to enable the Engine module to engage in secure transactions if so desired. The cryptographic module facilitates the secure accessing of resources on the Engine and facilitates the access of secured resources on remote systems; i.e., it may act as a client and/or server of secured resources. Most frequently, the cryptographic module communicates with information servers, operating systems, other program modules, and/or the like. The cryptographic module may contain, communicate, generate, obtain, and/or provide program module, system, user, and/or data communications, requests, and/or responses.

The Targeting/Distribution Engine Database

The Targeting/Distribution Engine database module 1019 may be embodied in a database and its stored data. The database is stored program code, which is executed by the CPU; the stored program code portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the Engine database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the Engine database is implemented as a data-structure, the use of the Engine database 1019 may be integrated into another module such as the Engine module 1035. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database module 1019 includes several tables 19a-c. A base data entry table 1019a includes fields such as, but not limited to: sponsor distribution and/or advertisement subscription parameters, preferred distribution targets, related base data entries, and/or the like. A content provider table 1019b includes fields such as, but not limited to: content provider IDs, general content descriptors, uploaded web user information, and/or the like. An web user table 1019c includes fields such as, but not limited to: web user ID, dynamic web user interaction data records, stored web user interaction data records, content provider registration data, salary data, opportunity type element, performance history, and/or the like.

In one embodiment, the Engine database may interact with other database systems. For example, employing a distributed database system, queries and data access by the Engine modules may treat the combination of the Engine database and other databases as a single database entity.

In one embodiment, user programs may contain various user interface primitives, which may serve to update the Engine. Also, various accounts may require custom database tables depending upon the environments and the types of clients the Engine may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database modules 1019a-c. The Engine may be configured to keep track of various settings, inputs, and parameters via database controllers.

The Engine database may communicate to and/or with other modules in a module collection, including itself, and/or facilities of the like. Most frequently, the Engine database communicates with the Engine module, other program modules, and/or the like. The database may contain, retain, and provide information regarding other nodes and data.

The Targeting/Distribution Engine

The Targeting/Distribution Engine (“the Engine”) module 1035 is stored program code that is executed by the CPU. The Engine affects accessing, obtaining and the provision of information, services, transactions, and/or the like across various communications networks.

The Engine module enables generation of transactions for investors to contribute to such various asset funds and achieve investment fund optimizations for such exchanges.

The Engine module enabling access of information between nodes may be developed by employing standard development tools such as, but not limited to: (ANSI) (Objective-) C (++), Apache modules, binary executables, database adapters, Java, JavaScript, mapping tools, procedural and object oriented development tools, PERL, Python, shell scrip ts, SQL commands, web application server extensions, WebObjects, and/or the like. In one embodiment, the Engine server employs a cryptographic server to encrypt and decrypt communications. The Engine module may communicate to and/or with other modules in a module collection, including itself, and/or facilities of the like. Most frequently, the Engine module communicates with the Engine database, operating systems, other program modules, and/or the like. The Engine may contain, communicate, generate, obtain, and/or provide program module, system, user, and/or data communications, requests, and/or responses.

Distributed Engine

The structure and/or operation of any of the Engine node controller components may be combined, consolidated, and/or distributed in any number of ways to facilitate development and/or deployment. Similarly, the module collection may be combined in any number of ways to facilitate deployment and/or development. To accomplish this, one may integrate the components into a common code base or in a facility that can dynamically load the components on demand in an integrated fashion.

The module collection may be consolidated and/or distributed in countless variations through standard data processing and/or development techniques. Multiple instances of any one of the program modules in the program module collection may be instantiated on a single node, and/or across numerous nodes to improve performance through load-balancing and/or data-processing techniques. Furthermore, single instances may also be distributed across multiple controllers and/or storage devices; e.g., databases. All program module instances and controllers working in concert may do so through standard data processing communication techniques.

The configuration of the Engine controller will depend on the context of system deployment. Factors such as, but not limited to, the budget, capacity, location, and/or use of the underlying hardware resources may affect deployment requirements and configuration. Regardless of if the configuration results in more consolidated and/or integrated program modules, results in a more distributed series of program modules, and/or results in some combination between a consolidated and distributed configuration, data may be communicated, obtained, and/or provided. Instances of modules consolidated into a common code base from the program module collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If module collection components are discrete, separate, and/or external to one another, then communicating, obtaining, and/or providing data with and/or to other module components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), process pipes, shared files, and/or the like. Messages sent between discrete module components for inter-application communication or within memory spaces of a singular module for intra-application communication may be facilitated through the creation and parsing of a grammar. A grammar may be developed by using standard development tools such as lex, yacc, XML, and/or the like, which allow for grammar generation and parsing functionality, which in turn may form the basis of communication messages within and between modules. Again, the configuration will depend upon the context of system deployment.

The entirety of this disclosure (including the Cover Page, Title, Headings, Field, Background, Summary, Brief Description of the Drawings, Detailed Description, Claims, Abstract, Figures, and otherwise) shows by way of illustration various embodiments in which the claimed inventions may be practiced. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further undescribed alternate embodiments may be available for a portion is not to be considered a disclaimer of those alternate embodiments. It will be appreciated that many of those undescribed embodiments incorporate the same principles of the invention and others are equivalent. Thus, it is to be understood that other embodiments may be utilized and functional, logical, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program modules (a module collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the invention, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, functional, features, logical, organizational, structural, topological, and/or other aspects of the disclosure are not to be considered limitations on the disclosure as defined by the claims or limitations on equivalents to the claims.

What is claimed is:

1. A method for distributing targeted advertisements comprising:
receiving a request for a distributed advertisement from a content provider;
extracting advertisement distribution parameters from the distributed advertisement request;
selecting an underlying base data entry based on an analysis of the extracted advertisement distribution parameters; and
transmitting a distributed advertisement for incorporation with content associated with the content provider.

2. The method of claim 1, further comprising:
processing the distributed advertisement request to extract content provider distribution characteristics.

3. The method of claim 2, further comprising:
processing the distributed advertisement request to extract web user characteristics.

4. The method of claim 3, wherein the web user characteristics include characteristics detailing dynamic web user interaction with the content provider.

5. The method of claim 4, wherein dynamic web user interaction is configured as a content provider registration characteristics.

6. The method of claim 3, wherein the extracted web user characteristics include active web user interaction characteristics.

7. The method of claim 6, wherein the active web user interaction characteristics include web user survey results.

8. The method of claim 3, wherein the extracted web user characteristics include passive web user interaction characteristics.

9. The method of claim 8, wherein the passive web user interaction characteristics includes cookie data associated with a web user that is collected by the content provider.

10. The method of claim 8, wherein the passive web user interaction characteristics include content provider search history associated with a web user.

11. The method of claim 2, wherein the content provider characteristics are used to create a base data entry pool of potential base data entries.

12. The method of claim 11, further comprising:
adjusting the contents of the initial base data entry pool based on extracted web user data characteristics.

13. The method of claim 11, further comprising:
creating a ranking of the contents of the initial base data entry pool based on analysis of extracted web user data characteristics and content provider characteristics.

14. The method of claim 13, wherein the ranking is refined based on an analysis of sponsor distribution parameters.

15. The method of claim 14, wherein the sponsor distribution parameters include a sponsor defined a number of impressions of the distributed advertisement associated with a selected base data entry.

16. The method of claim 1, wherein the distributed advertisement is transmitted to the content provider for incorporation with the requested content before being transmitted to the web user for display.

17. The method of claim 1, wherein the distributed advertisement is transmitted to the web user wherein it is incorporate with the requested content from the content provider.

18. The method of claim 17, wherein the target destination address is for the distributed advertisement is included as par of the distributed advertisement request.

19. A processor implemented method for managing advertisements comprising:
selecting an underlying base data entry from a system generated potential base data entry pool based on sponsor distribution parameters;
transferring the selected underlying base data entry to an advertisement creation module with the distribution parameters and web user characteristics;
retrieving the selected underlying base data entry and extract data elements from the base data entry for inclusion in a distributed advertisement;
incorporating the base data elements into an advertisement generation template; and
transmitting the generated advertisement for incorporation with provider content and distribution to a web user.

20. A system for distributing targeted advertisements comprising:
a memory;
a processor disposed in communication with said memory, and configured to issue a plurality of processing instructions stored in the memory, wherein the instructions issue signals to:
receive a request for a distributed advertisement from a content provider;
extract advertisement distribution parameters from the distributed advertisement request;
select an underlying base data entry based on an analysis of the extracted advertisement distribution parameters; and
transmit a distributed advertisement for incorporation with content associated with the content provider.

21. The system of claim 20, further comprising instructions configured to:
process the distributed advertisement request to extract content provider distribution characteristics.

22. The system of claim 21, further comprising instructions configured to:
process the distributed advertisement request to extract web user characteristics.

23. The system of claim 22, wherein the web user characteristics include characteristics detailing dynamic web user interaction with the content provider.

24. The system of claim 23, wherein dynamic web user interaction is configured as a content provider registration characteristics.

25. The system of claim 22, wherein the extracted web user characteristics include active web user interaction characteristics.

26. The system of claim 25, wherein the active web user interaction characteristics include web user survey results.

27. The system of claim 22, wherein the extracted web user characteristics include passive web user interaction characteristics.

28. The system of claim 27, wherein the passive web user interaction characteristics includes cookie data associated with a web user that is collected by the content provider.

29. The system of claim 27, wherein the passive web user interaction characteristics include content provider search history associated with a web user.

30. The system of claim 21, wherein the content provider characteristics are used to create a base data entry pool of potential base data entries.

31. The system of claim 30, further comprising instructions configured to:
adjust the contents of the initial base data entry pool based on extracted web user data characteristics.

32. The system of claim 30, further comprising instructions configured to:
create a ranking of the contents of the initial base data entry pool based on analysis of extracted web user data characteristics and content provider characteristics.

33. The system of claim 32, wherein the ranking is refined based on an analysis of sponsor distribution parameters.

34. The system of claim 33, wherein the sponsor distribution parameters include a sponsor defined a number of impressions of the distributed advertisement associated with a selected base data entry.

35. The system of claim 20, wherein the distributed advertisement is transmitted to the content provider for incorporation with the requested content before being transmitted to the web user for display.

36. The system of claim 20, wherein the distributed advertisement is transmitted to the web user wherein it is incorporate with the requested content from the content provider.

37. The system of claim 36, wherein the target destination address is for the distributed advertisement is included as par of the distributed advertisement request.

38. A system for managing advertisements comprising:
a memory;
a processor disposed in communication with said memory, and configured to issue a plurality of processing instructions stored in the memory, wherein the instructions issue signals to:
select an underlying base data entry from a system generated potential base data entry pool based on sponsor distribution parameters;
transfer the selected underlying base data entry to an advertisement creation module with the distribution parameters and web user characteristics;
retrieve the selected underlying base data entry and extract data elements from the base data entry for inclusion in a distributed advertisement;
incorporate the base data elements into an advertisement generation template; and
transmit the generated advertisement for incorporation with provider content and distribution to a web user.
